(19) United States
(12) Patent Application Publication
(10) Pub. No.: US 2026/0187125 A1
(43) Pub. Date: Jul. 2, 2026

(54) SYSTEMS AND METHODS FOR DYNAMIC SEARCH RESULT SUPPRESSION OR EXCLUSION

(71) Applicant: rewardStyle, Inc., Dallas, TX (US)

(72) Inventor: Alok GOYAL, Seattle, WA (US)

(21) Appl. No.: 19/426,862

(22) Filed: Dec. 19, 2025

Related U.S. Application Data
(60) Provisional application No. 63/738,862, filed on Dec. 26, 2024.

(51) Int. Cl. G06F 16/334; G06F 16/2453; G06F 40/284

(52) U.S. Cl. CPC G06F 16/3347; G06F 16/24534; G06F 40/284

(57) ABSTRACT

A query for a data object search may be received. The query may include a data object attribute to be suppressed or excluded in results of the data object search. The query may be tokenized to identify the data object attribute, and transformed into a vector, where a portion of the vector corresponds to the data object attribute. A modified vector may be generated by adjusting this portion of the vector, and a plurality of data objects responsive to the query and a plurality of scores corresponding to the plurality of data objects may be determined based on the modified vector. Computer-executable instructions configured to cause a user computing device to construct and display a user interface that displays at least a portion of the data objects according to the scores as the results of the data object search may be generated and transmitted to the user computing device.

### CROSS-REFERENCE TO RELATED APPLICATION(S)

This application claims the benefit of priority to U.S. Provisional Application No. 63/738,862, filed on December 26, 2024, the disclosure of which is incorporated herein in its entirety.

### TECHNICAL FIELD

The present disclosure relates generally to systems and methods for suppressing and/or excluding data objects associated with particular attributes within search results, and more specifically systems and methods utilizing vector-based approaches to facilitate the suppression and/or exclusion.

### BACKGROUND

Search platforms primarily focus on identifying and ranking data objects that are responsive to (e.g., that match) users’ queries for presentation as results. However, conventional search platforms fail to accurately and effectively process queries that include suppression and/or exclusion statements or criteria, leading to irrelevant or undesirable results contrary to the users’ intents.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

The techniques of this disclosure improve the state of query processing for queries that include suppression and/or exclusion statements or criteria by implementing a vector-based approach to facilitate such suppression and/or exclusion within the search results.

The techniques described herein relate to methods, systems, and/or non-transitory computer readable mediums for dynamic search result suppression and/or exclusion. For example, a query for a data object search may be received from a user computing device. The query may include a data object attribute to be suppressed or excluded in results of the data object search. The query may be tokenized to identify the data object attribute, and the tokenized query may be transformed into a vector, where a portion of the vector corresponds to the data object attribute. A modified vector may be generated by adjusting the portion of the vector corresponding to the data object attribute, and a plurality of data objects responsive to the query and a plurality of scores corresponding to the plurality of data objects may be determined based on the modified vector. Computer-executable instructions configured to cause the user computing device to construct and display a user interface that displays at least a portion of the plurality of data objects according to the plurality of scores as the results of the data object search may be generated and transmitted to the user computing device.

### BRIEF DESCRIPTION OF THE DRAWINGS

The accompanying drawings, which are incorporated in and constitute a part of this specification, illustrate various example embodiments and together with the description, serve to explain the principles of the disclosed embodiments.

FIG. 1 is a diagram showing an example of a search environment, according to some embodiments of the disclosure.

FIG. 2 is a flow chart showing an example process for dynamic search result suppression and/or exclusion, according to some embodiments of the disclosure.

FIG. 3 is a system flow diagram conceptually showing the example process described in FIG. 2, according to some embodiments of the disclosure.

FIG. 4 is an example user interface to facilitate dynamic search result suppression and/or exclusion, according to some embodiments of the disclosure.

FIG. 5 shows an implementation of a computer system that executes techniques presented herein, according to some embodiments of the disclosure.

### DETAILED DESCRIPTION

As briefly mentioned above, search platforms primarily focus on identifying and ranking data objects that are responsive to (e.g., that match) users’ queries for presentation as results. However, conventional search platforms fail to accurately and effectively process queries that include suppression and/or exclusion statements or criteria, leading to irrelevant or undesirable results contrary to the users’ intents.

To provide an illustrative example, when searching for an item, such as a clothing article, a user may want to avoid specific colors, brands, retailers, or other similar attributes. However, if a phrase or statement like “no red” or “exclude red” is received as part of a query to express the user’s intent to exclude items that are red (e.g., that have a red color attribute), a conventional search platform may identify the term “red” and resultantly return red items as search results contrary to the user’s intent. In other words, the conventional search platform may be unable to accurately interpret the association of “red” with “no” or “exclude” to identify the negation statement or exclusion criteria, and thus fail to exclude red items from the search results.

The present disclosure solves these problems and/or other problems described above or elsewhere in the present disclosure, namely by implementing a vector-based approach to improve the state of query processing for queries that include suppression and/or exclusion statements or criteria. Specifically, in response to receiving a query for a data object search that includes one or more attributes associated with the data object (e.g., data object attributes) to be suppressed and/or excluded, the data object attribute(s) to be suppressed and/or excluded may be identified though a query-to-vector transformation process. For example, a vector output by the process may be comprised of a plurality of vector portions representing different attributes associated with the data object being queried for, including (i) data object attributes to be included in the search (e.g., inclusion criteria), and (ii) the data object attribute(s) identified to be suppressed and/or excluded from the search (e.g., suppression or exclusion criteria). Each of the vector portions may be associated with a weight indicating a query relevance or importance of the data object attribute that the respective vector portion represents. The vector is then modified by adjusting any portion of the vector corresponding to the data object attribute(s) identified to be suppressed and/or excluded. The adjustment may include an adjusting (e.g., a decreasing) of the weight associated with the vector portion if the data object attribute represented by the vector portion is to be suppressed and/or a removing (e.g., subtracting) of the vector portion from the vector if the data object attribute represented by the vector portion is to be excluded.

The modified vector is then used to perform or execute the query on a vector-based data store to determine data objects responsive to the query and associated scores for ranking the data objects. Based on the use of the modified vector that decreases a weight associated with and/or removes any portion of the vector corresponding to the data object attribute(s) identified to be suppressed and/or excluded, any data objects associated with those data object attributes are therefore suppressed (e.g., limited in number and/or deprioritized in ranking) and/or excluded from the responsive data objects. Additionally, by implementing this vector-based approach to facilitate the suppression and/or exclusion of data object attributes, resource intensive changes to programming code and/or complexities of implementation of rule-based logic are avoided.

To provide an illustrative example of the improvement to the state of query processing, if a query including a negation statement (e.g., “maxi dress, no red”) was processed using conventional search platform techniques, a vector generated from the query and used to perform or execute the query on a vector-based data store would include a vector portion representing a color attribute of red (e.g., the context or intent that dresses with red color should be excluded would be missing). Resultantly, dresses that are red in color would be determined to be responsive to the query and included in the search results. In contrast, using the vector-based approach described herein, the vector generated from the query would be modified prior to performing or executing the query to remove or otherwise adjust (e.g., subtract out) the vector portion representing the color attribute of red from the vector based on an identification of the red color attribute as an attribute to be excluded to more accurately capture the intent.

While specific examples included throughout the present disclosure involve data object search, and particularly an item or product search, performed in a content creation platform context, it should be understood that techniques according to this disclosure may be adapted to any data object search performed via a standalone search engine/platform or as part of a larger electronic commerce (e-commerce) platform. It should also be understood that the examples above are illustrative only. The techniques and technologies of this disclosure may be adapted to any suitable activity.

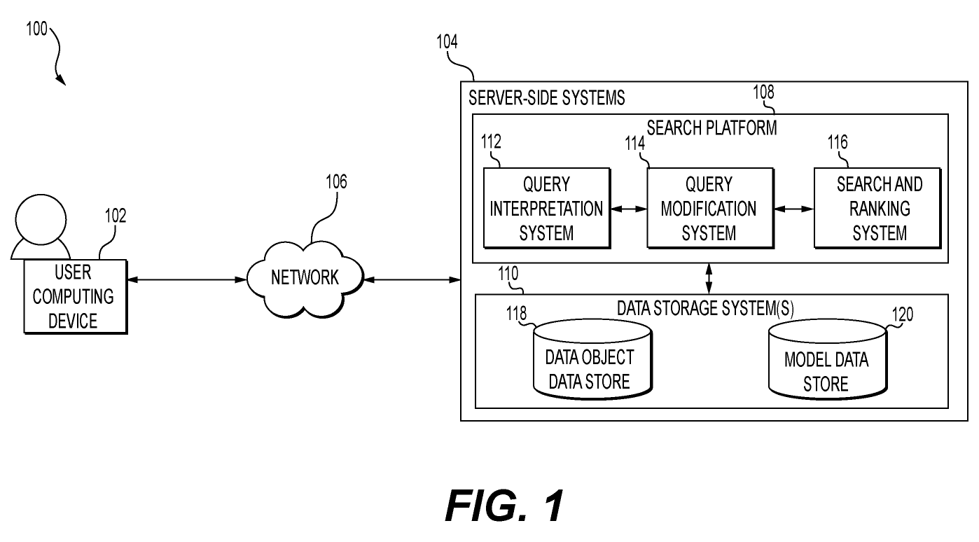

FIG. 1 is a diagram showing an example of a search environment 100, according to some embodiments of the disclosure. Search environment 100 may include a user computing device 102 communicating with one or more server-side systems 104 over a network 106. While one user computing device 102 is illustrated for brevity and clarity, the search environment 100 may support a plurality of user computing devices 102 communicating with the server-side systems 104 in parallel over the same network 106 or different networks.

The server-side systems 104 may include a search platform 108 and one or more data storage system(s) 110, among other systems. In some examples, the search platform 108 may be a sub-platform of a larger platform associated with a first entity. As one non-limiting example, the search platform 108 may be a sub-platform of a content creation platform. The content creation platform may enable content creators to, among other things, search for items (e.g., products), via the search platform 108, to include in monetized content generated and published via the content creation platform. In other examples, the search platform 108 may be a standalone search platform facilitating searches of any type of data object or a sub-platform of any other type of e-commerce platform.

In some embodiments, the search platform 108 and the data storage system(s) 110 may be associated with a common entity (e.g., the first entity). In such embodiments, the search platform 108 and the data storage system(s) 110 may be part of a cloud service computer system (e.g., in a data center). In other embodiments, the search platform 108 and the data storage system(s) 110 may be associated with a different entity than one another. For example, the data storage system(s) 110 may be associated with a third party that provides data storage services to the first entity. The systems and devices of the search environment 100 may communicate in any arrangement. As will be discussed herein, systems or devices of the search environment 100 may communicate in order to facilitate data object searches, among other activities.

The network 106 over which the one or more components of the search environment 100 communicate may include one or more wired or wireless networks, such as a wide area network (“WAN”), a local area network (“LAN”), personal area network (“PAN”), a cellular network (e.g., a 3G network, a 4G network, a 5G network, etc.) or the like. In some embodiments, the network 106 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” or “web page” or “page” generally encompasses a location, data store, or the like that is, for example, hosted or operated by a computer system so as to be accessible online, and that may include data configured to cause a program such as a web browser to perform operations such as send, receive, or process data, generate a visual display or an interactive interface, or the like. The user computing device 102 and one or more of the server-side systems 104 may be connected via the network 106, using one or more standard communication protocols. The user computing device 102 and one or more of the server-side systems 104 may transmit and receive communications from each other across the network 106, as discussed in more detail below.

The user computing device 102 may be configured to enable access to or interaction with other systems in the search environment 100 to transmit queries for data object searches to, and receive search results responsive to the transmitted queries from, the search platform 108. The user computing device 102 may be a computer system such as, for example, a desktop computer, a laptop computer, a tablet, a smart cellular phone (e.g., a mobile phone), a smart watch or other electronic wearable, etc.

In some embodiments, the user computing device 102 may include one or more electronic application(s), e.g., a program, plugin, browser extension, etc., installed on a memory of the respective devices. The electronic application(s) may include one or more of system control software, system monitoring software, software development tools, etc. In some embodiments, the electronic application(s) may be associated with one or more of the other components in the search environment 100. For example, one or more of the electronic application(s) may include client applications associated with one or more of the server-side systems 104 (e.g., a client application of the search platform 108 and/or of a larger platform that the search platform 108 is a sub-platform thereof). In some examples, one or more of the client applications may include thick client applications that are locally installed on the user computing device 102 (e.g., desktop applications or mobile applications). In other examples, one or more of the client applications may include thin client applications (e.g., web applications) that are rendered via a web browser launched on the user computing device 102.

Additionally, the user computing device 102 may generate, or may cause to be generated, one or more graphical user interfaces (GUIs) based on instructions or information stored in the memory, instructions or information received from the other systems in the search environment 100, or the like and may cause the GUIs to be displayed via a display of the user computing device 102. The GUIs may be, e.g., mobile application interfaces or browser user interfaces and may include text, input text boxes, selection controls, or the like. The display may include a touch screen or a display with other input systems (e.g., a mouse, keyboard, etc.) for the users of the respective devices to control the functions thereof.

In some embodiments, the user computing device 102 may be associated with a content creator subscribed to the above-described content creation platform, of which the search platform 108 is a sub-platform thereof. The content creator may interact with the content creation platform through a client application running on the user computing device 102 to generate content to recommend or otherwise promote an item of interest for which the content creator is seeking monetization for (e.g., seeking commissions based on purchases of the item resulting from interactions with the content). As part of the content generation process, the content creator may select an item search feature of the client application, and utilize this feature to generate a query to facilitate identification of the item of interest for inclusion in the content. Upon generation and submission of the query, the client application may transmit the query over the network 106 to the search platform 108. In return, and as described in more detail below, the search platform 108 may provide computer-executable instructions, via the client application over the network 106, to enable the user computing device 102 to construct and display a user interface to present items determined to be responsive to the query.

In other embodiments, the user computing device 102 may be associated with a consumer or a follower of a content creator utilizing an item search feature of the client application to try to locate one or more items of interest that may or may not be associated with the content creator.

The search platform 108 may include one or more server devices (or other similar computing devices) for executing search services. Example search services may include, but are not limited to, tasks associated with: interpreting queries; modifying the queries based on the interpretations to suppress and/or exclude data objects having particular attributes from search results; determining data objects responsive to the modified queries and an associated relevance of the data objects to the modified queries; and/or ranking, for display, the responsive data objects based, at least in part, on the associated relevance of the data objects to the queries. In some examples, and as illustrated in FIG. 1, the search platform 108 may include a plurality of systems, such as a query interpretation system 112, a query modification system 114, and a search and ranking system 116, each configured to perform a different subset of tasks to execute the search services, as described in detail below. While the search and ranking system 116 is shown as one system of the search platform 108 herein, in other examples, the search and ranking system 116 may be two separate systems, each dedicated to search and ranking, respectively.

The data storage system(s) 110 may include a server system, computer-readable memory such as a hard drive, flash drive, disk, etc. In some embodiments, the data storage system(s) 110 include or interact with an application programming interface for exchanging data to other systems, e.g., one or more of the other components of the search environment 100, such as at least the search platform 108. The data storage system(s) 110 may include a plurality of data stores, such as a data object data store 118 and a model data store 120. The data stores may include or act as a repository or source for various types of data.

The data object data store 118 may be configured to store a plurality of data objects queryable via the search and ranking system 116 of the search platform 108. The data objects may each have a plurality of attributes unique to a type or a category of the respective data object. To provide an illustrative example in the content creation platform scenario, the data objects stored may be items. The items may include goods or merchandise, such as products available for purchase or sale by one or more retailers or merchants. Example item attributes may include a brand, a collection, a size, a color, a style, and/or a retailer, among other similar attribute types, associated with a given item. The data objects stored in the data object data store 118 may include data objects scraped from external resources (e.g., scraped from the Internet), data objects previously interacted with by users (e.g., in the content creation platform scenario, items previously included in generated content and/or saved, favorited, or otherwise interacted with by a content creator), or the like. The data object data store 118 may be continuously updated to include new items as they are identified via scraping and/or via user interactions. In some embodiments, the data object data store 118 may be a vector-based database configured to store the data objects as vector representations of the data objects (e.g., as vectors) in a vector space. A vector for a data object may be a mathematical representation generated based on the attributes comprising the data object.

The model data store 120 may be configured to store any models, algorithms, and/or processes to be utilized by one or more components of the search platform 108 to execute the search services.

Although depicted as separate components in FIG. 1, it should be understood that a component or portion of a component in the system of the search environment 100 may, in some embodiments, be integrated with or incorporated into one or more other components. For example, one or more of data storage system(s) 110 may be integrated with the search platform 108 or the like. As another example, the query interpretation system 112, the query modification system 114, and/or the search and ranking system 116 may comprise a single system of the search platform 108. In some embodiments, operations or aspects of one or more of the components discussed above may be distributed amongst one or more other components. Any suitable arrangement or integration of the various systems and devices of the search environment 100 may be used.

In the following disclosure, various acts may be described as performed or executed by a component from FIG. 1, such as the user computing device 102 or one or more of the server-side systems 104, or components thereof. However, it should be understood that in various embodiments, various components of the search environment 100 discussed above may execute instructions or perform acts including the acts discussed below. An act performed by a device may be considered to be performed by a processor, actuator, or the like associated with that device. Further, it should be understood that in various embodiments, various steps may be added, omitted, or rearranged in any suitable manner.

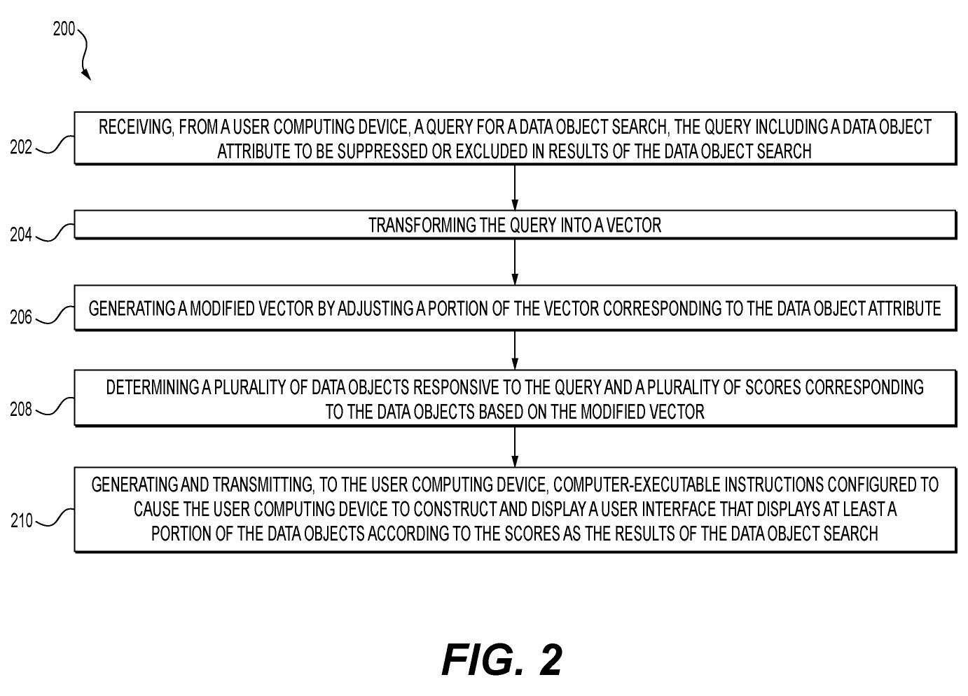

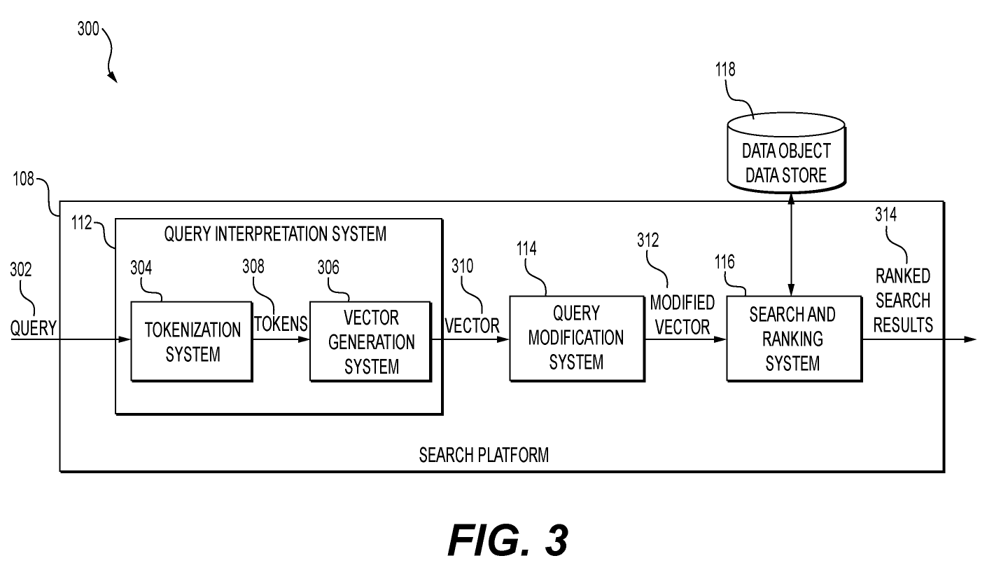

FIG. 2 is a flow chart showing an example process 200 for dynamic search result suppression and/or exclusion, according to some embodiments of the disclosure. FIG. 3 is a system flow diagram 300 conceptually showing the process 200 of FIG. 2, according to some embodiments of the disclosure. Referring concurrently to FIGS. 2 and 3, in some examples, the process 200 may be performed by one or more of the server-side systems 104, such as one or more components of the search platform 108.

At step 202, the process 200 may include receiving, from the user computing device 102, a query 302 for a data object search. The query 302 may include a data object attribute to be suppressed or excluded in results of the data object search.

To provide an illustrative example, the client application associated with the content creation platform described above with reference to FIG. 1 may be running on the user computing device 102, and the content creator may select to navigate to an item search feature of the client application. In response to the selection, the client application may display a search user interface (e.g., an item search page) having one or more control elements, such as a search field and/or one or more search filter control elements, for entering the query 302. As one example, the content creator may intend to generate content that promotes or otherwise recommends (e.g., for monetization purposes) a maxi dress, however the content creator does not want any red maxi dresses. To help the content creator identify the new maxi dress for inclusion in the content to establish a monetization pathway, the content creator may enter “maxi dress, no red” as the query 302 via the search field of the search user interface. The user computing device 102, via the client application, may then transmit the query 302 over the network 106 to the search platform 108.

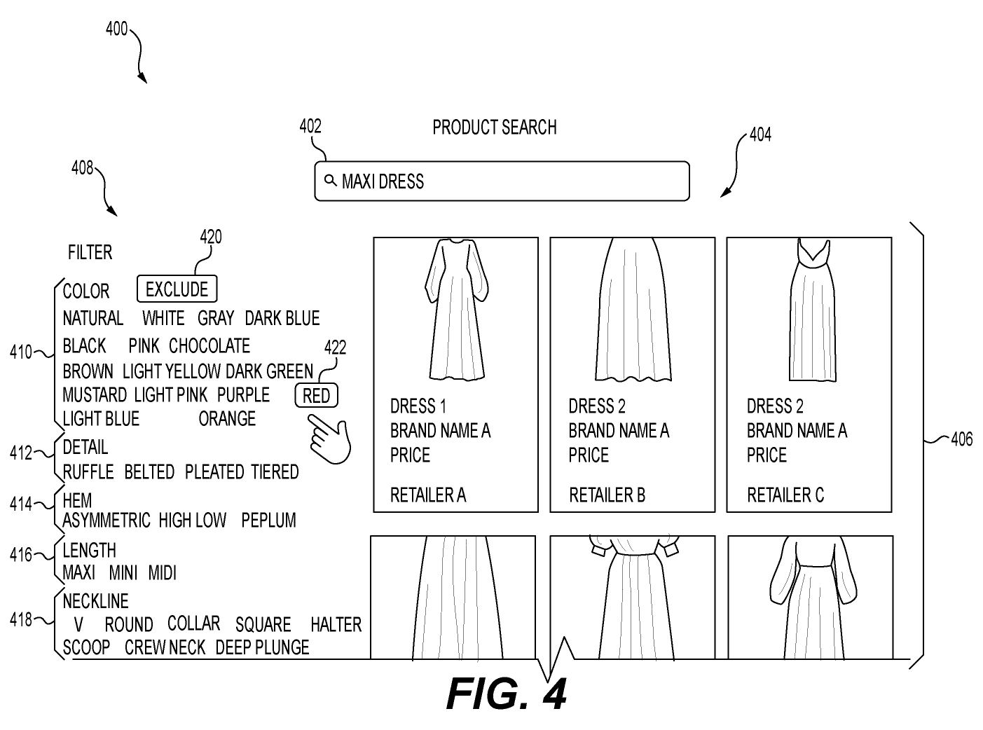

In some embodiments, a portion of the search filter control elements provided via the search user interface may allow a user to select data object attributes for suppression and/or exclusion to further refine a query input via the search field of the search user interface. For example, using a similar illustration as above, the content creator may enter “maxi dress” into the search field, and then select one or more search filter control elements to indicate that red color dresses are to be excluded. An exemplary user interface including exclusion search filter control elements is shown and described in detail below with reference to FIG. 4.

In examples where the query 302 includes a data object attribute to be suppressed, the suppression of the data object attribute may be explicitly defined (e.g., as an input statement or selected suppression attribute) in the query. For example, the query 302 may include a suppression statement (e.g., “dress, limit results from Retailer A”) indicating an intent of the user to limit the number of dresses that are sold by Retailer A from the results. In some examples the suppression statement may include an associated suppression value (e.g., “limit results from Retailer A by 70 %”). Additionally or alternatively, the suppression of the data object attribute may be automatically applied to at least a subset of a plurality of queries, including the query 302. For example, for any query associated with types of items that are sold by Retailer A, a suppression associated with a predefined suppression value may be automatically applied.

In examples where the query 302 includes a data object attribute to be excluded, the exclusion of the data object attribute may be explicitly defined (e.g., as an input statement or selected exclusion attribute) in the query 302. For example, the query 302 may include a negation statement (e.g., “no red” in “maxi dress, no red”) indicating an intent of the user to exclude any dresses that are red in color from the results.

In some examples, the query 302 received may be a refinement query refining an initial query that, for example, did not include any or included a different data object attribute to be suppressed or excluded. Additionally, while one data object attribute included in the query 302 for suppression or exclusion is discussed herein for brevity and clarity, in other examples, the query 302 may include two or more object attributes to be suppressed, two or more object attributes to be excluded, or a combination of one or more object attributes to be suppressed and one or more object attributes to be excluded.

At step 204, the process 200 may include transforming the query 302 into a vector 310. The query-to-vector transformation process may be performed using one or more natural language processing techniques to tokenize the query 302, and transform the tokenized query into the vector 310. In some examples, and as shown in FIG. 3, the query interpretation system 112 may include two sub-systems, a tokenization system 304 and a vector generation system 306. The query 302 may be comprised of text. The tokenization system 304 may be configured to receive the query 302, and convert the text into a plurality of tokens 308 to tokenize the query 302. For example, tokenization may be performed to divide the text into the tokens 308. The tokenization may include sentence, word, sub-word, and/or character-based tokenization, among other tokenization techniques known in the art.

The vector generation system 306 may be configured to generate the vector 310 based on the tokens 308. The vector 310 may be comprised of a plurality of vector portions, each corresponding to one or more of the tokens 308, where the vector 310 mathematically or numerically represents the meaning of and/or relationship among the tokens 308. For example, the tokens 308 may be parsed and interpreted to identify attributes of the data object being searched (or not being searched) for. For example, as part of the parsing and interpretation, at least one of the tokens 308 associated with the data object attribute to be suppressed or excluded may be identified based on an analysis of relationships among the tokens 308. As an illustrative example, if the query 302 includes a negation statement, such as “no red”, one of the tokens 308 may be associated with the word “no” and another of the tokens 308 may be associated with the word “red”, and based on an immediate proximity of these tokens 308 to one another, a color attribute of red is identified as the data object attribute to be excluded. Resultantly, at least one portion of the vector 310 corresponds to the at least one of the tokens 308 associated with the data object attribute to be suppressed or excluded, and thus corresponds to the data object attribute to be suppressed or excluded.

Each of the vector portions of the vector 310 may be associated with a weight. In some examples, the weight for a vector portion may be indicative of an importance or relevance of a given data object attribute represented by the vector portion to the overall query. In some examples, the weights may initially be predefined or otherwise randomly set, and then adjusted overtime based on user interactions with search results (e.g., become customized to the user).

At step 206, the process 200 may include generating a modified vector 312 by adjusting the portion of the vector 310 corresponding to the data object attribute. The modified vector 312 may then be used to query the data object data store 118 to determine results, as described with reference to step 208. Dependent on whether the data object attribute is to be suppressed or excluded, adjusting may include adjusting a weight of, or altogether removing, the portion of the vector 310 corresponding to the data object attribute.

In examples where the data object attribute is to be suppressed, generating the modified vector 312 may include adjusting a weight associated with the portion of the vector 310 corresponding to the data object attribute. For example, the weight may be decreased to indicate a diminished relevance or importance of that data object attribute to the query 302, and thus (i) limit a number of data objects associated with the data object attribute included within the results and/or (ii) deprioritize a ranking and display of such data objects in the results. The weight may be adjusted based on or according to the suppression value associated with the data object attribute (e.g., the suppression value included in the suppression statement or the predefined suppression value if suppression is being automatically applied).

In examples where the data object attribute is to be excluded, generating the modified vector 312 may include removing the portion of the vector 310 corresponding to the data object attribute from the vector 310 to generate the modified vector 312. For example, the portion of the vector 310 corresponding to the data object attribute (e.g., vector b) may be subtracted from the vector 310 (e.g., vector a) to yield the modified vector 312 (e.g., vector x, where vector a – vector b = vector x).

In some embodiments, the data object attribute included in the query 302 is a first data object attribute, and as part of the query transformation performed at step 204, one or more other data object attributes to be suppressed and/or excluded in the results of the data object search may be determined based on the first data object attribute 302. For example, a second data object attribute may not be explicitly defined in the query 302, but may be extrapolated from the parsing and interpreting of one or more of the tokens 308 associated with the first data object attribute.

To provide an illustrative example, a first data object attribute defined as a negation statement in the query 302 may be an exclusion attribute of no red color. A second exclusion attribute of no maroon color may be extrapolated and appended to the tokenized query under an assumption that if the user intent is to exclude red-colored data objects, this intent likely extends to excluding maroon-colored data objects (e.g., because maroon is a shade of red). To provide another illustrative example, a first data object attribute included in the query 302 for suppression or exclusion is Retailer A. Based on Retailer A being a major retailer, a plurality of suppression or exclusion attributes corresponding to each of a plurality of major retailers may be extrapolated and appended to the tokenized query under an assumption that if the user intent is to suppress or exclude data objects associated with one major retailer, this intent likely extends to suppressing or excluding data objects associated with any or all major retailers.

In such examples, additional tokens corresponding to the second data object attribute determined may be appended to the tokens 308 (e.g., to append the second data object attribute prior to transforming the tokenized query into the vector 310). Resultantly, the vector 310 resulting from the transformation at step 204 may include a first vector portion corresponding to the first data object attribute, and a second vector portion corresponding the second data object attribute. Then, at step 206, both of the first vector portion and the second vector portion of the vector 310 may be adjusted as described above to generate the modified vector 312.

At step 208, the process 200 may include determining a plurality of data objects responsive to the query 302 and a plurality of scores corresponding to the data objects based on the modified vector 312. To determine the data objects responsive to the query 302, the search and ranking system 116 may query the data object data store 118 using the modified vector 312. Based on the use of the modified vector 312 to query the data object data store 118 (e.g., as opposed to use of the vector 310), the data objects determined to be responsive to the query 302 suppress or exclude any data objects associated with the data object attribute to be suppressed or excluded.

As discussed in detail with reference to FIG. 1, the data object data store 118 may be a vector-based database configured to store the data objects as vector representations of the data objects (e.g., as vectors) in a vector space. A search of the vector space (e.g., a multi-dimensional graph search) of the data object data store 118 may be performed using the modified vector 312 to identify a plurality of vectors that are within a predefined distance of the modified vector 312 in the vector space. The vectors being within the predefined distance of the modified vector 312 indicates a similarity in one or more attributes of data objects that the vectors are representing with the attributes of the data object being queried for, and thus a relevancy or responsiveness of those data objects to the query 302. Resultantly, the vectors identified may represent the data objects determined to be responsive to the query 302.

Additionally, the scores corresponding to the data objects may be similarity scores determined using cosine similarity. For example, for each of the data objects determined to be responsive to the query 302, a cosine of an angle between the vector representing the data object and the modified vector 312 in the vector space is determined to yield a cosine similarity value for the respective data object. A smaller cosine similarity value indicates increased similarity of the vector to the modified vector 312, and thus a likely higher relevance or responsiveness of the respective data object to the query 302. The responsive data objects may then be ranked and otherwise ordered based on the corresponding scores to yield ranked search results 314. In some examples, the ranked search results 314 may be a listing of the responsive data objects in an order for display (e.g., a display sequence).

In some examples, prior to being ranked or ordered, the data objects may be grouped into clusters. In one, non-limiting example, the clusters may be generated using a hash-based clustering algorithm. For example, using the algorithm, hashes may be generated for the data objects, and compared amongst one another to identify subsets of data objects having a predetermined threshold similarity to include in each cluster. While hash-based clustering is disclosed herein, any other technique known in the art for grouping data objects into clusters may be utilized.

At step 210, the process 200 may include generating and transmitting, to the user computing device 102, computer-executable instructions configured to cause the user computing device 102 to construct and display a user interface that displays at least a portion of the data objects according to the scores as the results of the data object search (e.g., displays the ranked search results 314).

The instructions may include information associated with how to visually display the data objects within the user interface. For example, the instructions may include a position or arrangement of the data objects relative to one another within the user interface based on the ranking or ordering. To provide an illustrative example, the arrangement may indicate that the data objects are to be displayed row by row, with N items per row listed in the order provided in the ranked search results 314 from left to right. Additionally, the instructions may include a style or format for presentation of the data objects, along with any images and/or text associated with the data objects (e.g., obtained from the data object data store 118) to display in accordance with the style or format.

For brevity and clarity, the process 200 describes the receiving and processing of a query including one data object attribute. However, in other examples, a query that is received and processed via the process 200 may have a plurality of data object attributes to be suppressed, excluded, or a combination thereof (e.g., a first set of one or more of the plurality of data object attributes are to be suppressed, while a second set of one or more of the plurality of data object attributes are to be excluded). In such examples, at step 206, the modified vector may be generated by adjusting each portion of the vector corresponding to each data object attribute (e.g., adjusting a weight associated with or removing each respective portion dependent on whether the respective data object attribute is to be suppressed or excluded). In other words, the modified vector used to query the data object data store 118 to determine results, as described with reference to step 208, accounts for the suppression or exclusion of each of the plurality of data object attributes within the query.

As briefly mentioned above, and as described in more detail below with reference to FIG. 4, the user interface displaying the results of the data object search may include a plurality of search filter control elements, where a portion of the filter control elements may allow the user to select additional data object attributes for suppression and/or exclusion to further refine the query via the user interface. If the user selects one or more additional data object attributes for suppression and/or exclusion, steps 202-210 may be repeated and refined results of the data object search may be dynamically displayed. The refined results may limit a number of or push data objects associated with any additional data object attributes selected for suppression lower in ranking and thus display, and/or remove data objects associated with any additional data object attributes selected for exclusion.

Accordingly, certain embodiments may be performed for dynamic search result suppression and/or exclusion. The process 200 described above is provided merely as an example, and may include additional, fewer, different, or differently arranged steps than depicted in FIGS. 2-3 describing the process 200 and/or portions thereof.

FIG. 4 is an example user interface 400 to facilitate dynamic search result suppression and/or exclusion, according to some embodiments of the disclosure. The user interface 400 may be an example user interface of the application associated with the content creation platform running on the user computing device 102. The user interface 400 includes a search bar 402 via which the user provides textual input indicating a product to be searched for (e.g., “maxi dress” as an initial query) and a results section 406 displaying data objects 404 responsive to “maxi dress”.

The user interface 400 may also include a plurality of search filter sections 408, including a first section 410, a second section 412, a third section 414, a fourth section 416, a fifth section 418, and so on, for use in refining the initial query. Each of the search filter sections 408 is associated with a data object attribute type, and may include a plurality of selectable data object attributes of the data object attribute type. Here, based on the product being queried for (e.g., a “maxi dress”), data object attribute types may be attributes types specific to clothing items, and specifically dresses. For example: the first section 410 is associated with color and includes selectable color attributes (e.g., neural, white, gray, dark blue, etc.); the second section 412 is associated with detail and includes selectable detail attributes (e.g., ruffle, belted, pleated, and tiered); the third section 414 is associated with hem and includes selectable hem attributes (e.g., asymmetric, high low, and peplum); the fourth section 416 is associated with length and includes selectable length attributes (e.g., maxi, mini, and midi); and the fifth section 418 is associated with neckline and includes selectable neckline attributes (e.g., V, round, collar, etc.).

In some examples, the selectable data object attributes included in each of the search filter sections 408 may be based on attributes extracted from a scanning and analysis of images and/or text associated with the data objects 404 that are being displayed as search results (e.g., in results section 406). For example, for the first section 410, colors identifiable from images and/or text associated with the data objects 404 may be included as selectable color attributes. Relying on the extracted attributes to build or generate the selectable data object attributes within the search filter sections 408 (e.g., as opposed to conventional back end filtering techniques) may help improve overall functionality of the search platform 108, and particularly the search and ranking system 116. For example, when applying filtering-based techniques, search systems often adapt at least one of two approaches, each resulting in challenges addressed in turn below. One approach may be to pre-filter the data and then search for nearby vectors, which becomes too expensive for a search system, as latencies may be increased as data is analyzed and pre-filtered. A second approach may be post-filtering of the data after searching for nearby vectors. However, ample results may not be available to provide as search results back to the user computing device 102.

Selection of a selectable data object attribute from one of the search filter sections 408 may indicate the selected data object attribute is to be added as an inclusion criterion to refine the initial query (e.g., is a data object attribute to be searched for in a refinement query). Dependent on the type of data object being searched for and an intent of the user, searching using one or more exclusion criteria may be more efficient. For example, if the user is interested in any maxi dress color except for red, it would be more efficient for the user to indicate the color attribute of red as an exclusion criterion (e.g., a data object attribute to be excluded), rather than for the user to select every other color attribute as inclusion criteria in the first section 410. Therefore, to facilitate searching using one or more exclusion criteria, one or more of the search filter sections 408, such as the first section 410 associated with color may have an exclusion control element 420. If the exclusion control element 420 is selected along with one of the selectable color attributes (e.g., color attribute of red 422), as shown, the color attribute of red 422 may be identified as a data object attribute to be excluded in the refinement query. The refinement query may be an example of the query 302 processed using steps 202-210 of the process 200 described above with reference to FIG. 2.

While FIG. 4 only shows the exclusion control element 420 in the user interface 400, other example user interfaces may include similar control elements to facilitate searching using one or more suppression criteria. For example, a suppression control element may be provided that enables the user to indicate a particular data object attribute type of a data object attribute to suppress and an associated suppression value.

The user interface 400 described above is provided merely as an example, and may include additional, fewer, different, or differently arranged information and/or interactive control elements than depicted in FIG. 4.

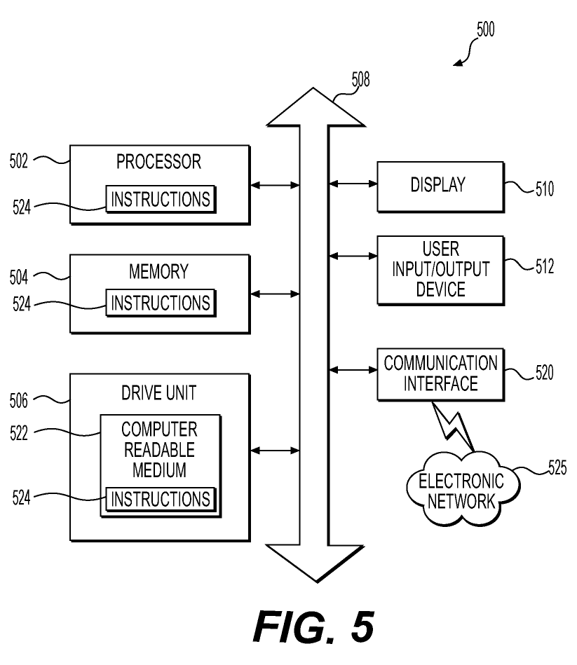

FIG. 5 shows an implementation of a computer system 500 that executes techniques presented herein, including processes or operations depicted in, or described with respect to, FIGS. 2-4, according to some embodiments of the disclosure. For example, the computer system 500 may be configured as one of the user computing device 102, one of the server-side systems 104, or another device according to exemplary embodiments of this disclosure. In various embodiments, any of the systems herein may be a computer system 500 including, e.g., a data communication interface 520 for packet data communication. The computer system 500 may communicate with one or more other computer systems 500 using the electronic network 525. The electronic network 525 may include a wired or wireless network similar to the network 106 depicted in FIG. 1.

The computer system 500 also may include a central processing unit (“CPU”), in the form of one or more processors 502, for executing program instructions 524. The program instructions 524 may include instructions for running one or more operations of the respective device or system. The computer system 500 may include an internal communication bus 508, and a drive unit 506 (such as read-only memory (ROM), hard disk drive (HDD), solid-state disk drive (SDD), etc.) that may store data on a computer readable medium 522, although the computer system 500 may receive programming and data via network communications. The computer system 500 may also have a memory 504 (such as random access memory (RAM)) storing instructions 524 for executing techniques presented herein, although the instructions 524 may be stored temporarily or permanently within other modules of computer system 500 (e.g., processor 502 or computer readable medium 522). The computer system 500 also may include user input and output ports 512 or a display 510 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, e.g., may enable loading of the software from one computer or processor into another. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, an automobile entertainment system, a home entertainment system, etc. Also, the disclosed embodiments may be applicable to any type of Internet protocol. It should be understood that embodiments in this disclosure are exemplary only, and that other embodiments may include various combinations of features from other embodiments, as well as additional or fewer features.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for dynamic search result suppression or exclusion, the method comprising:
receiving, from a user computing device, a query for a data object search, the query including a data object attribute to be suppressed or excluded in results of the data object search;
tokenizing the query to identify the data object attribute;
transforming the tokenized query into a vector, wherein a portion of the vector corresponds to the data object attribute;
generating a modified vector by adjusting the portion of the vector corresponding to the data object attribute;
determining a plurality of data objects responsive to the query and a plurality of scores corresponding to the plurality of data objects based on the modified vector; and
generating and transmitting, to the user computing device, computer-executable instructions configured to cause the user computing device to construct and display a user interface that displays at least a portion of the plurality of data objects according to the plurality of scores as the results of the data object search.

2. The computer-implemented method of claim 1, wherein the data object attribute is to be excluded, and generating the modified vector includes:
removing the portion of the vector corresponding to the data object attribute from the vector to generate the modified vector.

3. The computer-implemented method of claim 2, wherein the data object attribute to be excluded is explicitly defined as a negation statement in the query.

4. The computer-implemented method of claim 1, wherein the data object attribute is to be suppressed, and generating the modified vector includes:
adjusting, based on a suppression value associated with the data object attribute, a weight associated with the portion of the vector corresponding to the data object attribute.

5. The computer-implemented method of claim 4, wherein the data object attribute to be suppressed is explicitly defined in the query or the suppression of the data object attribute is automatically applied to at least a subset of a plurality of queries, including the query, received.

6. The computer-implemented method of claim 1, wherein the query comprises text, and tokenizing the query comprises:
converting the text into a plurality of tokens; and
parsing and interpreting the plurality of tokens to identify the data object attribute.

7. The computer-implemented method of claim 6, wherein transforming the tokenized query into the vector comprises:
generating the vector based the plurality of tokens, wherein the portion of the vector corresponding to the data object attribute is generated based on one or more of the plurality of tokens associated with the data object attribute.

8. The computer-implemented method of claim 1, wherein the data object attribute is a first data object attribute, the portion of the vector corresponding to the data object attribute is a first portion of the vector, and generating the modified vector further comprises:
determining a second data object attribute to be suppressed or excluded in the results of the data object search based on the first data object attribute, the second data object attribute not explicitly defined in the query received;
appending the second data object attribute to the tokenized query prior to transforming the tokenized query into the vector such that a second portion of the vector corresponds to the second data object attribute; and
generating the modified vector by further adjusting the second portion of the vector.

9. The computer-implemented method of claim 1, wherein determining the plurality of data objects responsive to the query comprises:
querying a data object data store, using the modified vector, wherein the data object data store is a vector-based database configured to store data object vectors in a vector space, and the plurality of data objects determined to be responsive to the query correspond to a plurality of the data object vectors identified as being within a predefined distance of the modified vector in the vector space.

10. The computer-implemented method of claim 9, wherein determining the plurality of scores corresponding to the plurality of data objects comprises:
determining a cosine similarity value between the modified vector and each of the plurality of the data object vectors to yield a plurality of cosine similarity values for the plurality of data objects corresponding to the plurality of the data object vectors; and
determining the plurality of scores for the plurality of data objects based on the plurality of cosine similarity values for the plurality of data objects.

11. The computer-implemented method of claim 10, wherein, based on the use of the modified vector to query the data object data store, the plurality of data objects determined to be responsive to the query suppress or exclude any data objects associated with the data object attribute.

12. The computer-implemented method of claim 10, wherein the user interface is a second user interface, and the method further comprising:
generating and transmitting, to the user computing device, computer-executable instructions configured to cause the user computing device to construct and display a first user interface including a search bar and a search filter section associated with a data object attribute type of the data object attribute, the search filter section having an exclusion control element and a plurality of data object attributes, including the data object attribute, of the data object attribute type, wherein the query is received in response to an indication of a selection of the exclusion control element and the data object attribute from the search filter section to refine input entered in the search bar via the first user interface.

13. A system for dynamic search result suppression or exclusion, the system comprising:
one or more processors; and
at least one memory storing instructions that, when executed by the one or more processors, cause the one or more processors to perform operations including:
receiving, from a user computing device, a query for a data object search, the query including a data object attribute to be suppressed or excluded in results of the data object search;
tokenizing the query to identify the data object attribute;
transforming the tokenized query into a vector, wherein a portion of the vector corresponds to the data object attribute;
generating a modified vector by adjusting the portion of the vector corresponding to the data object attribute;
determining a plurality of data objects responsive to the query and a plurality of scores corresponding to the plurality of data objects based on the modified vector; and
generating and transmitting, to the user computing device, computer-executable instructions configured to cause the user computing device to construct and display a user interface that displays at least a portion of the plurality of data objects according to the plurality of scores as the results of the data object search.

14. The system of claim 13, wherein generating the modified vector comprises one of:
removing the portion of the vector corresponding to the data object attribute from the vector to generate the modified vector when the data object attribute is to be excluded; or
adjusting, based on a suppression value associated with the data object attribute, a weight associated with the portion of the vector corresponding to the data object attribute when the data object attribute is to be suppressed.

15. The system of claim 13, wherein the query comprises text, and tokenizing the query comprises:
converting the text into a plurality of tokens; and
parsing and interpreting the plurality of tokens to identify the data object attribute.

16. The system of claim 15, wherein transforming the tokenized query into the vector comprises:
generating the vector based the plurality of tokens, wherein the portion of the vector corresponding to the data object attribute is generated based on one or more of the plurality of tokens associated with the data object attribute.

17. The system of claim 13, wherein the data object attribute is a first data object attribute, the portion of the vector corresponding to the data object attribute is a first portion of the vector, and generating the modified vector further comprises:
determining a second data object attribute to be suppressed or excluded in the results of the data object search based on the first data object attribute, the second data object attribute not explicitly defined in the query received;
appending the second data object attribute to the tokenized query prior to transforming the tokenized query into the vector such that a second portion of the vector corresponds to the second data object attribute; and
generating the modified vector by further adjusting the second portion of the vector.

18. The system of claim 13, wherein determining the plurality of data objects responsive to the query comprises:
querying a data object data store, using the modified vector, wherein:
the data object data store is a vector-based database configured to store data object vectors in a vector space,
the plurality of data objects determined to be responsive to the query correspond to a plurality of the data object vectors identified as being within a predefined distance of the modified vector in the vector space, and
based on the use of the modified vector to query the data object data store, the plurality of data objects determined to be responsive to the query suppress or exclude any data objects associated with the data object attribute.

19. The system of claim 18, wherein determining the plurality of scores corresponding to the plurality of data objects comprises:
determining a cosine similarity value between the modified vector and each of the plurality of the data object vectors to yield a plurality of cosine similarity values for the plurality of data objects corresponding to the plurality of the data object vectors; and
determining the plurality of scores for the plurality of data objects based on the plurality of cosine similarity values for the plurality of data objects.

20. A non-transitory computer readable medium for dynamic search result suppression or exclusion, the non-transitory computer readable medium storing instructions which, when executed by one or more processors, cause the one or more processors to perform operations comprising:
receiving, from a user computing device, a query for a data object search, the query including a data object attribute to be suppressed or excluded in results of the data object search;
tokenizing the query to identify the data object attribute;
transforming the tokenized query into a vector, wherein a portion of the vector corresponds to the data object attribute;
generating a modified vector by adjusting the portion of the vector corresponding to the data object attribute;
determining a plurality of data objects responsive to the query and a plurality of scores corresponding to the plurality of data objects based on the modified vector; and
generating and transmitting, to the user computing device, computer-executable instructions configured to cause the user computing device to construct and display a user interface that displays at least a portion of the plurality of data objects according to the plurality of scores as the results of the data object search.
